(19) United States
(12) Patent Application Publication
(10) Pub. No.: US 2010/0321165 A1
(43) Pub. Date: Dec. 23, 2010

(54) RFID READER PERFORMING IMPEDANCE MATCHING TO PREVENT PERFORMANCE DETERIORATION

(75) Inventor: Joo Hyung Lee, Seoul (KR)

Correspondence Address: CANTOR COLBURN LLP, 20 Church Street, 22nd Floor, Hartford, CT, 06103, US

(73) Assignee: BLUEBIRD SOFT CO., LTD., Seoul (KR)

(21) Appl. No.: 12/865,482

(22) PCT Filed: Jan. 30, 2009
(86) PCT No.: PCT/KR09/00463

§ 371 Date: Jul. 30, 2010

(30) Foreign Application Priority Data
Jan. 30, 2008 (KR) 10-2008-0009576

(51) Int. Cl. H04Q 5/22

(52) U.S. Cl. 340/10.4

(57) ABSTRACT

A radio frequency identification (RFID) reader is provided. The RFID reader performs impedance matching based on a radio frequency (RF) signal received from a tag and whether the RFID reader has been attached to a human body, thereby prevent performance deterioration caused by an impedance change of an antenna due to permittivity of the human body when the RFID reader is used being attached to the human body.

### TECHNICAL FIELD

The present invention relates to radio frequency identification (RFID), and more particularly, to an RFID reader capable of impedance matching to prevent performance from deteriorating due to the change of impedance when attached to a human body.

### BACKGROUND ART

Radio frequency identification (RFID) technology was developed in the middle of 20th century and has drawn attention since it started to be used for inventory management and supply chain management (SCM) at the end of 1990s.

RFID technology is recognizing information stored in an RFID tag using an RFID reader. The RFID tag stores diverse tag information in re-writable memory. The tag information may include purchase information regarding a product or goods to which the RFID tag is attached and also include advertisement and events as well.

Recently, application of RFID has increased in the various fields of industry such as process management, SCM, access management, logistics, warehouse management, retail trade, library and renting store management, payment for transportation, non-cash payment, medical service, amusement park and event business, security, and entertainment business. Also, the use of RFID devices attachable to a human body has increased.

When an RFID device, e.g., an RFID reader, is used being attached to a human body, the impedance of an antenna of the RFID reader changes due to the permittivity of the human body. The change of the impedance may deteriorate the performance of the RFID reader.

### DETAILED DESCRIPTION OF THE INVENTION

### Technical Goal of the Invention

The present invention provides a radio frequency identification (RFID) reader for preventing performance deterioration that occurs when it is used being attached to a human body.

The present invention also provides an impedance matching method of a radio frequency identification (RFID) reader for preventing performance deterioration that occurs when it is used being attached to a human body.

### EFFECT OF THE INVENTION

According to the present invention, a radio frequency identification (RFID) performs impedance matching of an antenna upon a radio frequency (RF) signal received through the antenna, thereby preventing performance deterioration occurring when the RFID reader is used being attached to a human body.

### BRIEF DESCRIPTION OF THE DRAWINGS

FIG. 1 is a block diagram of a radio frequency identification (RFID) system according to some embodiments of the present invention.

FIG. 2 is a block diagram of an RFID reader according to some embodiments of the present invention.

FIG. 3 is a diagram showing the structure of an impedance matching unit illustrated in FIG. 2.

FIG. 4 is a diagram showing an RFID reader attached to a human body according to some embodiments of the present invention.

FIG. 5 is a flowchart of an impedance matching procedure of an RFID reader according to some embodiments of the present invention.

### BEST MODE FOR CARRYING OUT THE INVENTION

According to an aspect of the present invention, there is provided a radio frequency identification (RFID) reader capable of impedance matching for prevention of performance deterioration when the RFID reader is attached to a human body. The RFID reader includes a receiver, a sensor, a processor, and an impedance matching unit.

The receiver converts a radio frequency signal received through an antenna into a baseband signal. The sensor detects whether the RFID reader has been attached to the human body and may be an infrared sensor. The processor generates at least one control signal based on the baseband signal and whether the RFID reader has been attached to the human body.

The processor determines whether performance of the RFID reader is deteriorated based on a change of the baseband signal, which results from an impedance change of the antenna due to permittivity of the human body when the RFID reader is attached to the human body, and generates the at least one control signal based on a result of the determination on performance deterioration.

The impedance matching unit performs impedance matching of the antenna upon the radio frequency signal received through the antenna in response to the at least one control signal. Impedance of the impedance matching unit may change to a predetermined impedance in response to the at least one control signal.

The impedance matching unit may include an impedance changer including at least one element whose impedance changes in response to the at least one control signal. The impedance changer may include at least one inductor whose inductance changes in response to the at least one control signal. The impedance changer may include at least one capacitor whose capacitance changes in response to the at least one control signal.

The impedance matching unit may further include a connector configured to electrically connect the impedance changer to the antenna. The RFID reader may further include a display unit configured to receive tag information extracted by the processor from the baseband signal and display the tag information on a screen.

According to an aspect of the present invention, there is provided an impedance matching method of a radio frequency identification (RFID) reader for prevention of performance deterioration when the RFID reader is attached to a human body. The method includes converting a radio frequency signal received through an antenna into a baseband signal; detecting whether the RFID reader has been attached to the human body; and performing impedance matching of the antenna upon the radio frequency signal received through the antenna based on whether the RFID reader has been attached to the human body.

The method may further include generating at least one control signal based on the baseband signal and whether the RFID reader has been attached to the human body, The impedance matching of the antenna is performed in response to the at least one control signal.

The method may further include determining whether performance of the RFID reader is deteriorated based on a change of the baseband signal, which results from an impedance change of the antenna due to permittivity of the human body when the RFID reader is attached to the human body. The at least one control signal is generated based on a result of the determination on performance deterioration.

### Embodiments

The attached drawings for illustrating preferred embodiments of the present invention are referred to in order to gain a sufficient understanding of the present invention, the merits thereof, and the objectives accomplished by the implementation of the present invention.

Hereinafter, the present invention will be described in detail by explaining preferred embodiments of the invention with reference to the attached drawings. Like reference numerals in the drawings denote like elements.

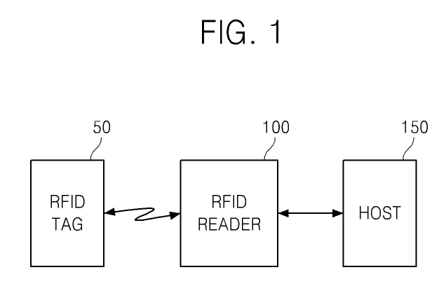

FIG. 1 is a block diagram of a radio frequency identification (RFID) system according to some embodiments of the present invention. Referring to FIG. 1, the RFID system includes a tag 50, an RFID reader 100, and a host 150.

The tag 50 is attached to a product and stores data, i.e., tag information. Tag information may include purchase information regarding a product or goods to which the RFID tag is attached and also include advertisement and events as well.

The RFID reader 100 is connected to the host 150 (e.g., a personal digital assistant (PDA) or a mobile phone) and communicates data with the host 150. The RFID reader 100 also recognizes the tag information based on a radio frequency (RF) signal transmitted from the tag 50 using RF communication.

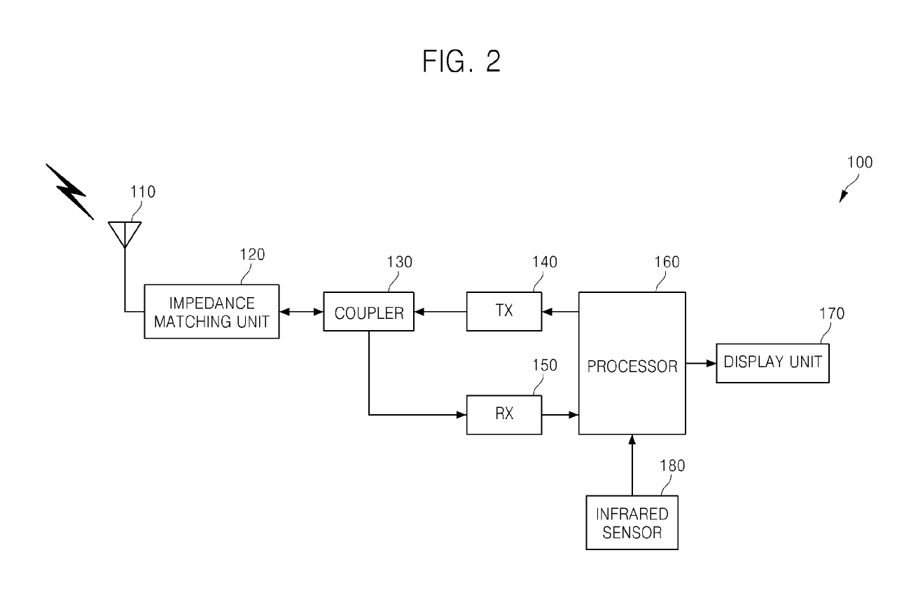

FIG. 2 is a block diagram of the RFID reader 100 according to some embodiments of the present invention. Referring to FIG. 2, the RFID reader 100 includes an antenna 110, an impedance matching unit 120, a coupler 130, a transmitter 140, a receiver 150, a processor 160, a display unit 170, and a sensor 180.

The antenna 110 receives an RF signal including tag information from the tag 50. The impedance matching unit 120 performs impedance matching of the antenna 110. In detail, the impedance matching unit 120 performs impedance matching of an RF signal received through the antenna 110 in response to one or more control signals CS1, CS2, CS3, and CS4 output from the processor 160.

The impedance matching unit 120 may perform impedance matching only when the RFID reader 100 is attached to a human body. The impedance of the impedance matching unit 120 may change to a predetermined impedance in response to the one or more control signals CS1 through CS4. The predetermined impedance may be set in advance to allow the magnitude of a baseband signal output from the receiver 150 to be maximum. This means that the impedance matching unit 120 functions to prevent performance deterioration that may occur when the RFID reader 100 is attached to a human body.

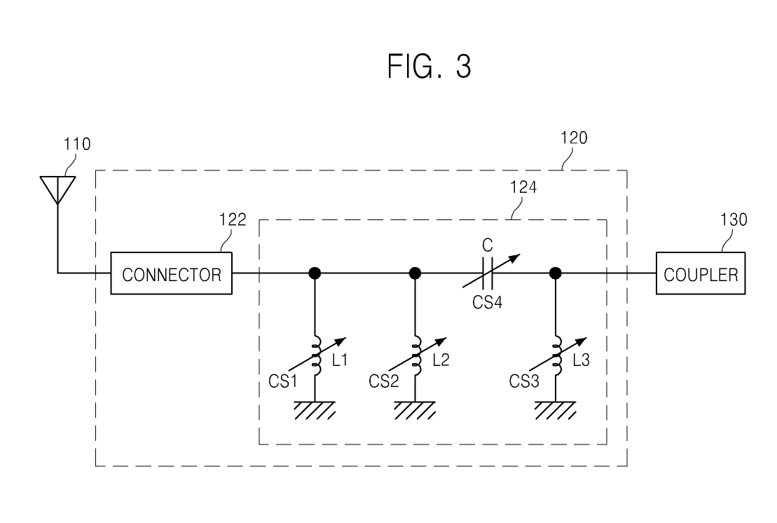

FIG. 3 is a diagram showing the structure of the impedance matching unit 120 illustrated in FIG. 2. Referring to FIG. 3, the impedance matching unit 120 includes an impedance changer 124 and a connector 122. The impedance changer 124 may include at least one element whose impedance changes in response to the at least one control signal CS1, CS2, CS3, or CS4. The impedance changer 124 may include at least one inductance L1, L2, or L3 whose inductance changes in response to the at least one control signal CS1, CS2, CS3, or CS4 and at least one capacitor C whose capacitance changes in response to the at least one control signal CS1, CS2, CS3, or CS4.

Although it is illustrated in FIG. 3 that the impedance changer 124 includes a plurality of the inductors L1 through L3 and the capacitor C, whose impedances change in response to the at least one control signal CS1, CS2, CS3, or CS4, the structure shown in FIG. 3 is just one example, and the present invention is not restricted thereto. The connector 122 electrically connects the impedance changer 124 to the antenna 110.

The coupler 130 outputs an RF signal received through the antenna 110 or an RF signal received from the impedance matching unit 120 to the receiver 150. The coupler 130 also outputs an RF signal received from the transmitter 140 to the antenna 110. The coupler 130 is provided to prevent interference between the transmitter 130 and the receiver 150. The coupler 130 may be implemented by a circulator or a directional coupler.

The receiver 150 converts an RF signal received through the antenna 110 and the coupler 130 into a baseband signal and outputs the baseband signal. The baseband signal may include tag information. The sensor 180 detects whether the RFID reader 100 has been attached to a human body and may be an infrared sensor.

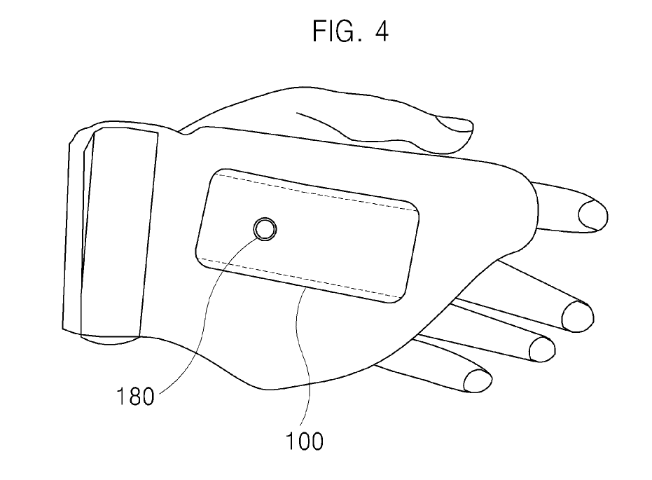

FIG. 4 is a diagram showing the RFID reader 100 attached to a human body according to some embodiments of the present invention. Referring to FIG. 4, the sensor 180 detects whether the RFID reader 100 has been attached to a human body. The RFID reader 100 performs impedance matching of the antenna 110 upon an RF signal received through the antenna 110 based on whether the RFID reader 100 has been attached to a human body.

The processor 160 generates the at least one control signal CS1, CS2, CS3, or CS4 based on a baseband signal output from the receiver 150 and whether the RFID reader 100 has been attached to a human body. The processor 160 determines whether the performance of the RFID reader 100 is deteriorated based on a change of the baseband signal, which results from the impedance change of the antenna 110 caused by the permittivity of a human body when the RFID reader 100 is attached to the human body, and generates the at least one control signal CS1, CS2, CS3, or CS4 based on the determination result.

The display unit 170 receives tag information extracted by the processor 160 from a baseband signal and displays the tag information on a screen. The display unit 170 may be a liquid crystal display (LCD) device or an organic electroluminescent display (OELD) device.

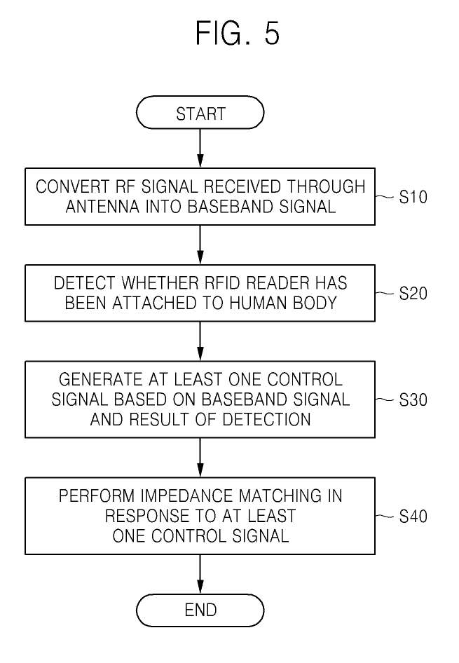

FIG. 5 is a flowchart of an impedance matching procedure of the RFID reader 100 according to some embodiments of the present invention. The impedance matching procedure will be described in detail with reference to FIGS. 1 through 3 and FIG. 5.

The antenna 110 receives an RF signal from the RFID tag 50, the coupler 130 transfers the RF signal received through the antenna 110 to the receiver 150, and the receiver 150 converts the RF signal into a baseband signal in operation S10. The sensor 180 detects whether the RFID reader 100 has been attached to a human body in operation S20. The processor 160 determines whether the performance of the RFID reader 100 is deteriorated based on a change of the baseband signal and generates the at least one control signal CS1, CS2, CS3, or CS4 based on the determination result to prevent performance deterioration in operation S30.

The impedance matching unit 120 performs impedance matching in response to the at least one control signal CS1, CS2, CS3, or CS4 to compensate for the performance deterioration in operation S40.

While the present invention has been particularly shown and described with reference to exemplary embodiments thereof, it will be understood by those of ordinary skill in the art that various changes in forms and details may be made therein without departing from the spirit and scope of the present invention as defined by the following claims.

### INDUSTRIAL APPLICABILITY

A radio frequency identification (RFID) reader according to some embodiments of the present invention can be used in the various fields of industry such as process management, supply chain management (SCM), access management, logistics, warehouse management, retail trade, library and renting store management, payment for transportation, non-cash payment, medical service, amusement park and event business, security, and entertainment business.

1.-9. (canceled)

10. A radio frequency identification (RFID) reader capable of impedance matching for prevention of performance deterioration when the RFID reader is attached to a human body, the RFID reader comprising:
a receiver configured to convert a radio frequency signal received through an antenna into a baseband signal;
a sensor configured to detect whether the RFID reader has been attached to the human body; and
an impedance matching unit configured to perform impedance matching of the antenna upon the radio frequency signal received through the antenna based on whether the RFID reader has been attached to the human body.

11. The RFID reader of claim 10, further comprising a processor configured to generate at least one control signal based on the baseband signal and whether the RFID reader has been attached to the human body,
wherein the impedance matching unit performs the impedance matching of the antenna in response to the at least one control signal.

12. The RFID reader of claim 11, wherein the sensor is an infrared sensor.

13. The RFID reader of claim 11, wherein the processor determines whether performance of the RFID reader is deteriorated based on a change of the baseband signal, which results from an impedance change of the antenna due to permittivity of the human body when the RFID reader is attached to the human body, and generates the at least one control signal based on a result of the determination on performance deterioration.

14. The RFID reader of claim 11, wherein impedance of the impedance matching unit changes to a predetermined impedance in response to the at least one control signal.

15. The RFID reader of claim 11, wherein the impedance matching unit comprises an impedance changer comprising at least one element whose impedance changes in response to the at least one control signal.

16. The RFID reader of claim 15, wherein the impedance changer comprises at least one inductor whose inductance changes in response to the at least one control signal.

17. The RFID reader of claim 15, wherein the impedance changer comprises at least one capacitor whose capacitance changes in response to the at least one control signal.

18. The RFID reader of claim 15, wherein the impedance matching unit further comprises a connector configured to electrically connect the impedance changer to the antenna.

19. The RFID reader of claim 11, further comprising a display unit configured to receive tag information extracted by the processor from the baseband signal and display the tag information on a screen.

20. An impedance matching method of a radio frequency identification (RFID) reader for prevention of performance deterioration when the RFID reader is attached to a human body, the method comprising:
converting a radio frequency signal received through an antenna into a baseband signal;
detecting whether the RFID reader has been attached to the human body; and
performing impedance matching of the antenna upon the radio frequency signal received through the antenna based on whether the RFID reader has been attached to the human body.

21. The method of claim 20, further comprising generating at least one control signal based on the baseband signal and whether the RFID reader has been attached to the human body,
wherein the impedance matching of the antenna is performed in response to the at least one control signal.

22. The method of claim 20, further comprising determining whether performance of the RFID reader is deteriorated based on a change of the baseband signal, which results from an impedance change of the antenna due to permittivity of the human body when the RFID reader is attached to the human body, and
wherein the at least one control signal is generated based on a result of the determination on performance deterioration.
